(19) United States
(12) Patent Application Publication
(10) Pub. No.: US 2007/0088647 A1
(43) Pub. Date: Apr. 19, 2007

(54) REVENUE BEARING, COMMODITY AND PRECIOUS METAL INVESTMENT INSTRUMENT AND METHOD

(76) Inventor: Torsten F. Caspar, Frankfurt (DE)

Correspondence Address: MOETTELI & ASSOCIATES SARL, ST. LEONHARDSTRASSE 4, ST. GALLEN, CH-9000, CH

(21) Appl. No.: 11/470,302

(22) Filed: Sep. 6, 2006

Related U.S. Application Data
(60) Provisional application No. 60/714,744, filed on Sep. 7, 2005.

(51) Int. Cl. G06Q 40/00

(52) U.S. Cl. 705/36 R

(57) ABSTRACT

An investment method is provided that allows the investor can participate with 100% of its investment in the development of the “underlying” (such as Gold)—no Cap and no Floor and is able to generate Income out of the active managed collateral, after deducting the costs for hedging or storage insurance.

This application claims priority to U.S. Provisional Application Ser. No. 60/714,744 entitled REVENUE BEARING, PHYSICAL GOLD INVESTMENT INSTRUMENT AND METHOD filed 7 Sep. 2005, the contents of which are incorporated herein by reference thereto.

### FIELD OF THE INVENTION

The present invention is in the field of financial business practices. More specifically, the present invention relates to banking and investment methods for investing in Commodities and/or precious metals.

### BRIEF DESCRIPTION OF THE DRAWINGS

FIG. 1 is a block diagram example of the present interest bearing, commodity or precious metal investment instrument method illustrating the primary operative components of the method and their inter-relationship.

FIG. 2 is a table showing three groups of market participants in the market segment of gold investments.

FIG. 3 is a schematic representation of the relationship of the Asset Management Group, the Depository Group and the Trust/Oversight Group components comprising the SPV enterprise of the present invention.

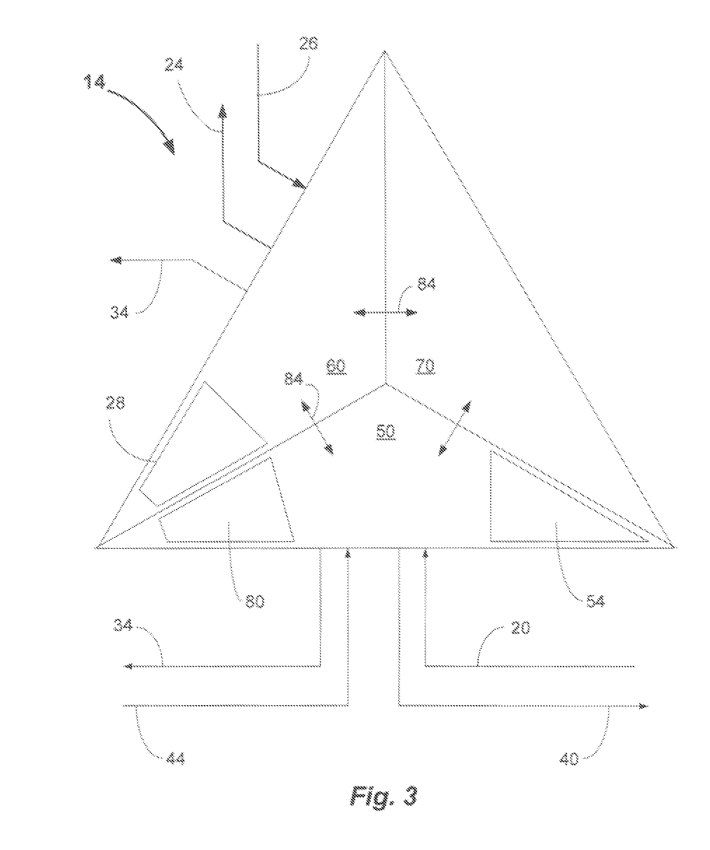

FIG. 4A is a diagram of a precious metal (gold) lending investment vehicle.

FIG. 4B is a diagram of a precious metal (gold) future roll over investment vehicle.

FIG. 5 is a diagram of the roll over strategy (based on the example Gold).

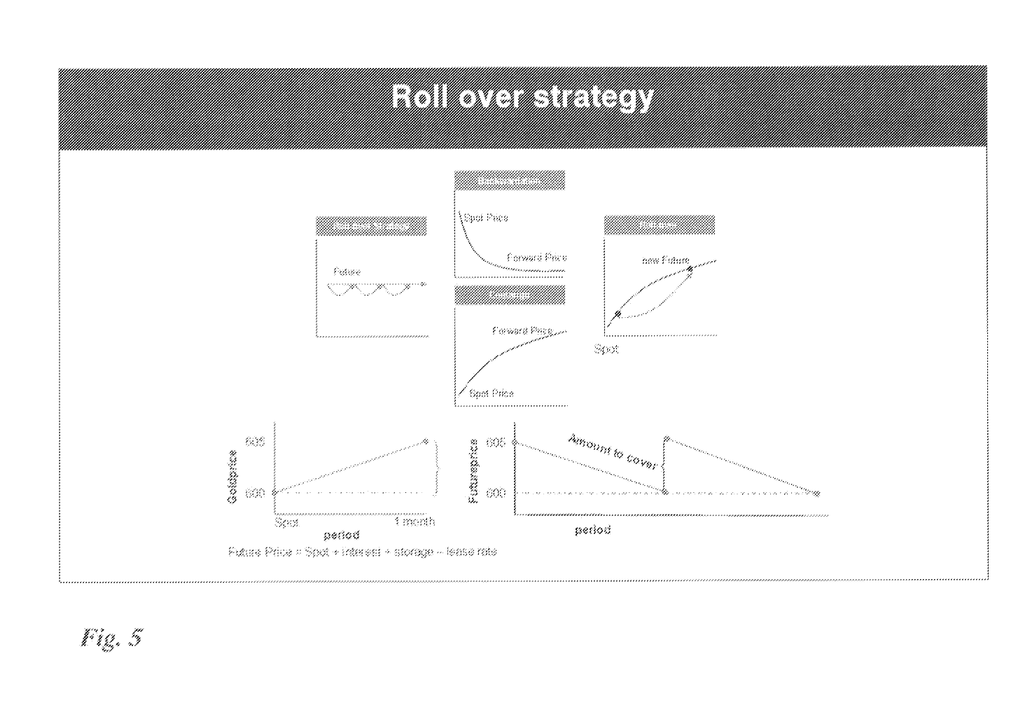

### DESCRIPTION OF THE INVENTION

The major disadvantage of a precious metal investment, gold being the classic example and other precious metals or commodities, always has been the lack of a continuous income related to it. Historically, investments in physical precious metals not only ties up cash, but also has the disadvantage of generating recurring costs, e.g., for physical storage, insurance and financial carrying costs. In times of low or moderate inflation, when accompanied by a sideward trend of the precious price, a precious metals investment becomes of financial relevance for the investment community.

A solution to the innately flat or often negative return on a precious metals holding, is to somehow develop a vehicle providing a positive return on the holding. The present invention resolves this problem through the securitization of an investment strategy that is able to track to price of the underlying (e.g. Gold) and additionally generate income payable to the investor.

In general: The following description explains the general method, based on the example gold. It is intended to patent this strategy for each of the precious metals or any other commodity such as (orange juice, wheat, coffee, cattle, gold, silver, and oil etc.) In general all commodities with traded derivatives on the NYMEX (US) or any other future exchange.

Referring now to the drawings, the details of preferred embodiments of the present invention are graphically and schematically illustrated. Like elements in the drawings are represented by like numbers, and any similar elements are represented by like numbers with a different lower case letter suffix.

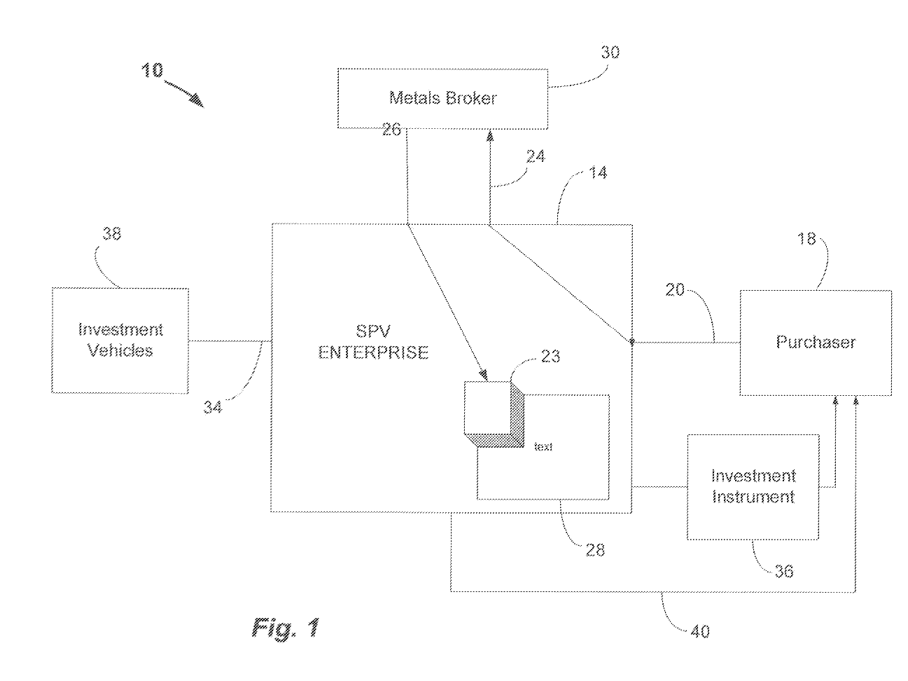

The present invention related to an investment and asset management method providing a revenue bearing certificate on a precious metal or commodity asset. The revenue bearing, precious metal or commodity instrument and investment method comprises establishing a special purpose vehicle enterprise, the special purpose vehicle (SPV) enterprise operating according to an operational plan. As illustrated in FIG. 1, the SPV enterprise 14 is set up to receive and process requests 20 for the purchase and divestment of a precious metal asset. Also, the SPV enterprise 14 is disposed to hold purchased physical precious metal or derivatives based on the precious metal 23 as held precious metal assets or derivatives based on the precious metal 28 for the benefit of purchasers 18 prior to divestment.

As exemplified in FIG. 1, the present investment method 10 defines a unique relationship between the special purpose vehicle (SPV) enterprise 14 of the present invention and the purchasers/stakeholders 18 who found the enterprise 14 by their money purchase 20 of a physical item or amount of a precious metal from or through the SPV enterprise 14. The SPV enterprise 14 makes an acquisition 24 for value and receives a delivery 26 of precious metal from a metals broker 30 or derivatives (Futures/Forwards/Options) with the right to buy precious metal from a Exchange 30. An instrument 36 evidencing the transaction is generated and drawn to the benefit of the purchaser 18 who is now a stakeholder in the SPV enterprise 14. The acquired precious metal or derivatives 23 is held and combined with other held precious metal or derivatives 28 as an investment asset of the SPV enterprise 14 and use as value 34 to find selected investment vehicles 38 as means of making investments.

In practice, the SPV enterprise 14 takes a purchase request (and payment) 20 from a purchaser 18, for a weight or item of a physical precious metal. In response, to the request 20, the SPV enterprise 14 purchases the requested weight or item of precious metal for the purchaser 18. The source of the purchased precious metal 23 can be from precious metal reserves owned by the enterprise, or the enterprise can broker the sale of the precious metal from a third party source 30, such as a precious metals broker. At completion of the purchase transaction initiated by the purchase request 20, the enterprise 14 issues a precious metal instrument 36 vested in the purchaser 18 evidencing the ownership and all attendant rights of ownership of the weight/item of purchased precious metal. At this point, the purchaser 18 is additionally a stakeholder in the SPV enterprise 14. The SPV enterprise 14 holds the purchased precious metal 23 in trust for the purchaser 18 as held precious metal 28 and an asset of the enterprise 14.

As noted above, the held precious metal 28 is an asset of the SPV enterprise 14, which the enterprise 14 uses as value/collateral for funding investments to derive a return on the investments. In point of fact, the enterprise 14 can use the held precious metal asset 28 in any and all manners of appropriate investment vehicles known in the field for the purpose of deriving a return on the investment for the “benefit”of purchasers/stake holder 18 is the payment of a portion of the derived return as revenue on the precious metal instrument.

In a preferred embodiment, the precious metal instrument 36 is for ownership of a precious metal selected from the group consisting of: gold, silver, platinum and platinum group metals, including palladium, rhodium, iridium, ruthenium, and osmium or any other commodity such as oil, natural gas, corn, cattle, coffee, energy etc. Most preferably the present interest bearing, precious metal investment instrument and method 10 is practiced for physical gold and silver. Additionally, the interest bearing, precious investment instrument 36 includes a certification of compliance that the bullion meets a standard of weight and of purity. Such standard could be an in-house standard or one of the standards known in the field, for example, the standards published by The London Bullion Market Association or the responsible exchange standards. Other standards are known to and selectable by the ordinary skilled artisan for practice in the present invention.

Upon receiving a divestment type request 20 from the purchase/stake holder 18, the SPV enterprise 14 divests the relevant held physical precious metal 28 pursuant to the request 20 and conditions of the investment instrument 36. The divestment can comprise payment of cash or other consideration for the value of the investment instrument 36, delivery of a requisite amount and purity of bullion to the divesting stake holder 18, or delivery of a specific item of bullion to the stake holder 18.

In a preferred embodiment, the precious metal instrument 36 provides the right for the owner upon divestment to have the owned precious metal itself tendered into the possession of the purchaser/stake holder 18. Under appropriate conditions, the precious metal instrument vested 36 can evidence the ownership of a specific piece of precious metal, in much the same way as a title of a deed might. Such conditions might exist as when a purchaser is a “private investor” or a “gold fan” type of investor that has physical gold to invest in the SPV enterprise 14 rather than cash. See Table I. This “purchaser” is in fact an “exchanger,” and the purchase request 20 is in fact an “exchange” request, asking to submit the purchaser's own precious metal to be held by the SPV enterprise 14 as held precious metal 28 in exchange for an investment instrument 36.

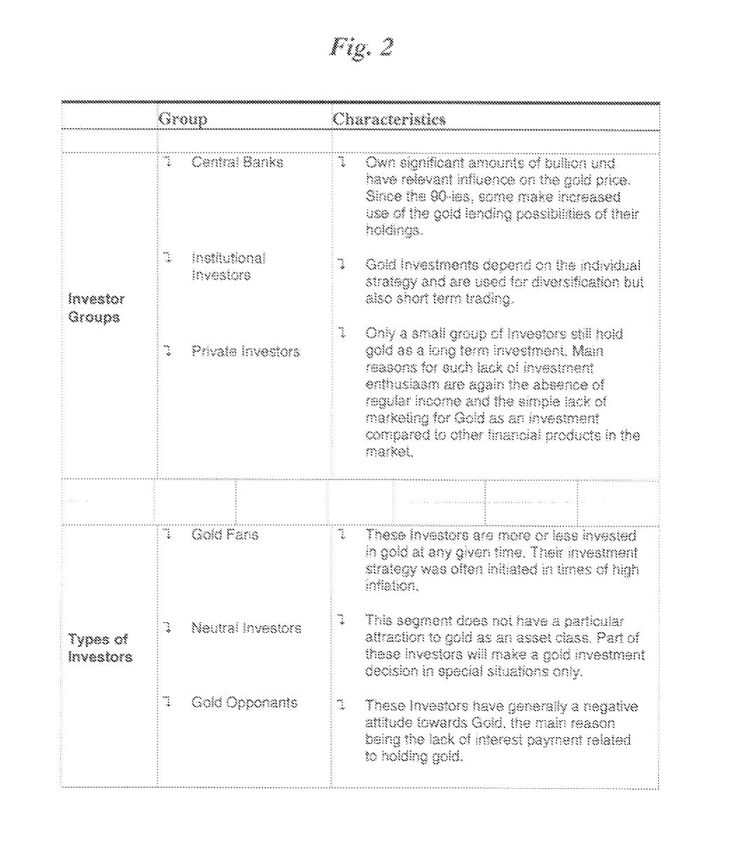

As shown in FIG. 2, the special purpose vehicle enterprise 14 comprises three operational groups: an Asset Management Group 50, a Depository 60 and a Trustee 70. In the present invention 10, asset management is the process managing the assets and returns for the benefit of the purchasers/stake holders 18. This is accomplished typically through stocks, bonds and/or cash equivalents, and/or any number of other investment vehicles known to and selectable by on of ordinary skill in the field of precious metal asset investment. Professional investment counselors 54 manage these assets according to specific stated objectives or investment styles. Inter alia, the Asset Management Group 50 provides overall management of the enterprise 14. The professional counselors 54 of the Management Group 50 provide the strategic decision-making for the investment process to enhance productivity and provide alternative solutions for effective utilization of enterprises assets. The role of the Asset Management Group 50 is to provides a disciplined approach to cost analysis, a method for analyzing allocation trade-offs between initiatives, tools and information for assuring compliance with the mission of the enterprise and furtherance of the interest of the stakeholders 18.

The Trustee Group 70 provides oversight 84 of the SPV enterprise 14 to assure compliance with all governmental regulations and requirements, and to assure compliance of the enterprise with its operational plan, and to provide any other accountability measures that are required or appropriate. The Trustee Group 70 should have a degree of autonomy from other groups of the SPV enterprise. Typically, the Trustee Group 70 will have the qualities of a fiduciary usual in the investment industry, including established mechanism of accountability, and will provide the services standard in the industry. Of course the Trustee Group has an appropriate degree of autonomy and independence for the rest of the SPV enterprise, to avoid questions of conflict of interest.

In a preferred embodiment, the Trustee 70 of the SPV enterprise 14 is a trustee appointed/approved by a national government. Such a government appointed or approved trustee could be an actual federal governmental agency (e.g., a national finance ministry), a quasi-governmental agency (e.g., similar to the USPS in the US), or a federal government appointed trustee. In a preferred embodiment, the Trustee Group is provided by a national governmental finance office, such as the Finance Office of the nation of Luxembourg. Other national governments have actual or quasi-governmental agencies appropriate to provide the desired oversight, such as any major western nation, and many smaller stable nations/governments with an established banking and financial services infrastructures: e.g., the channel Islands, Liechtenstein and others. However, under appropriate circumstances, the Trustee Group 70 may be in-house.

The Depository Group 60 is any entity duly qualified to handle and store precious metal bullion or a portfolio of derivatives. In addition to appropriate storage and handling capabilities, this component of the SPV enterprise 14 must have appropriate security and accountability characteristics as well. An appropriate Depository Group 60 could be an established bank experienced in the precious metals investment business or a precious metals brokerage house.

The present revenue bearing, physical gold investment instrument and method includes an operational plan 80. The operational plan provides the guidelines and organizational structure under which the Asset Management Group 50, the Depository Group 60 and the Trustee Group 70 operate. Under the operations plan 80, the Asset Management Group 50 provides an actively managed investment instrument 36, paying (for the first time) a continuous return 40 on a precious metal bullion holding 28. The stake holder 18 participates in all changes of the market price of the held precious metal 28.

The investment instrument 36 shall be issued by the Asset Management Group 50 of the SPV enterprise to purchasers 18 in exchange (usually) for cash. The investment instrument 36 is a bearer certificate offered to the general public for the purchase of a amount of a precious metal. The cash received from purchaser is used exclusively to acquire the amount and type of precious metal bullion or an appropriate amount of derivatives to buy the precious metal represented by the investment instrument 36. In this manner, the precious metal asset of the purchaser becomes securitized for the investor/purchaser 18, and a physical asset of the SPV enterprise 14. The held precious metal or the derivatives 28 represents the asset on the SPV enterprise's balance sheet, and the instrument 36 sold to investors/purchasers 18 are on the liability side.

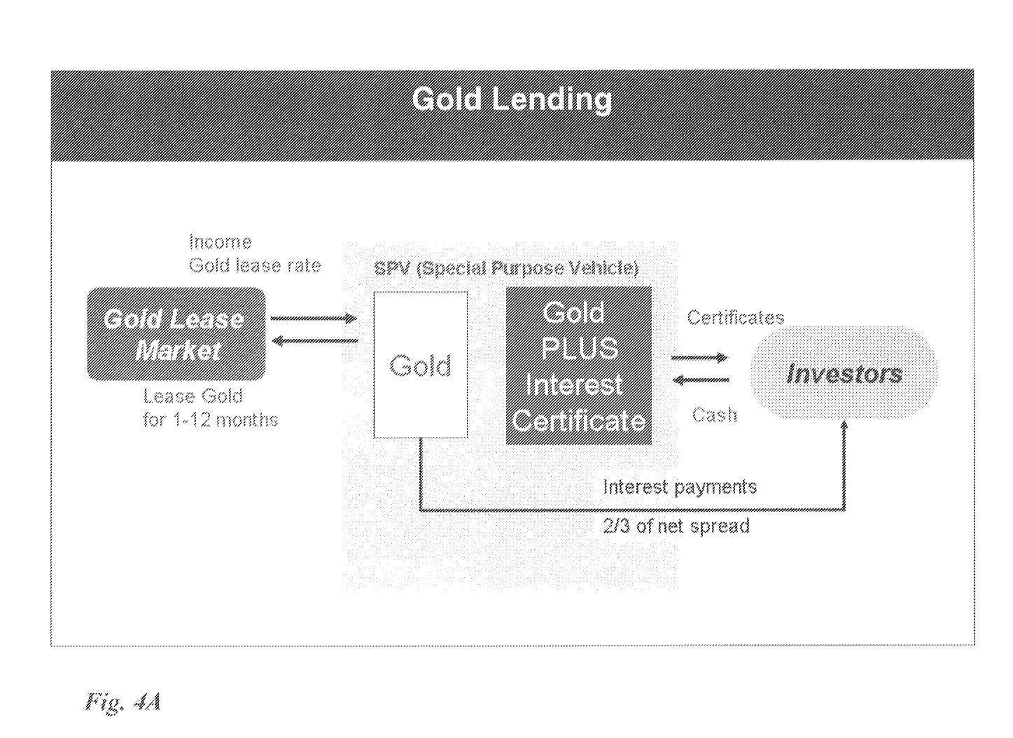

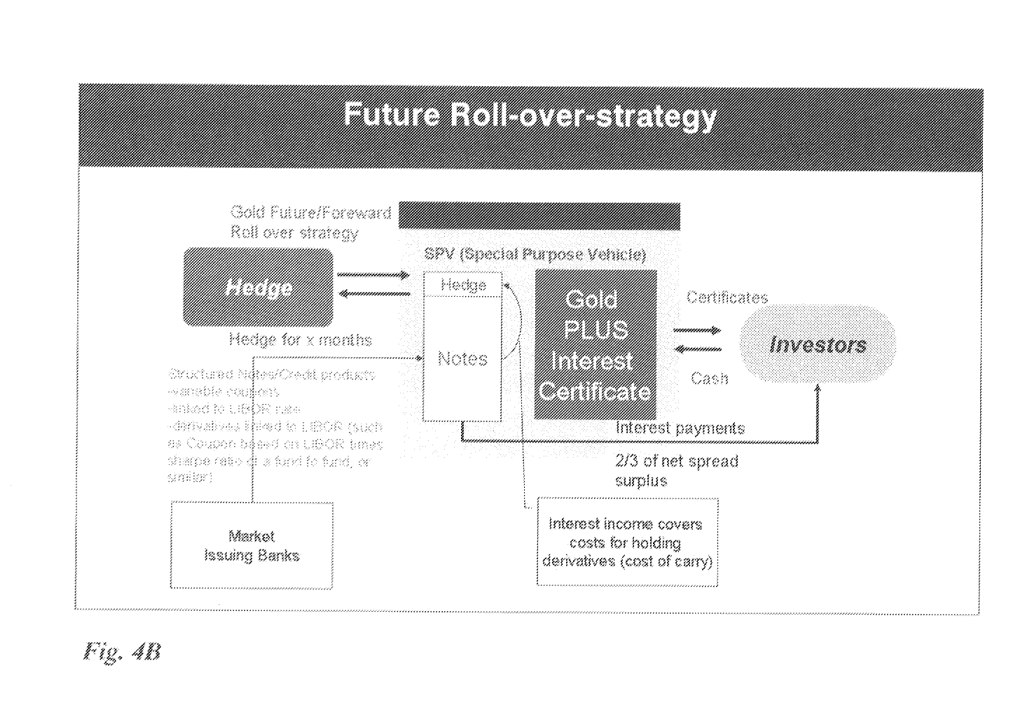

The held precious metal asset 28 is continuously managed by a professional consulting team 54 of the Asset Management Group 50. The investment of the held precious metal asset 28 can be accomplished using any of a number of investment vehicles 38 known to and selectable by one of ordinary skill in the industry. For example, as shown in FIGS. 4A and 4B, the asset can be leased or the short term derivatives can be rolled into a long term derivatives (sell the short term derivative and buy a long term derivative) and used as collateral to purchase other fixed income securities. The Asset Management Group 50 under the guidance of appropriate investment consultants 54, can build other certificates using proceeds, say from asset lending or the remaining funds in case of the investment in derivatives (usage of the collateral), to purchase other option contracts (put, call and/or a combination of both) related to other underlying assets like currencies, commodities (metals, oil, etc), indices, shares, bonds etc and/or baskets from a combination of any of the above as means to generate a return. After deduction of storage and insurance cost for the gold bullions, part of the generated return is distributed to the stake holder 18.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A revenue bearing, precious metal instrument and investment method, the method comprising the steps of:
establishing a special purpose vehicle, the special purpose vehicle being an enterprise operating according to an operational plan and being disposed to receive and process purchase requests and disposition requests for the purchase and divestment of a precious metal or a derivative to buy a precious metal, and to hold purchased precious metal or derivative (held precious metal) for the benefit of a purchaser prior to disposition;
receiving and processing a purchase request for a weight of the precious metal by the enterprise, and purchasing the weight of the precious metal for the purchaser in response to the purchase request;
issuing a precious metal instrument vested in the purchaser evidencing the ownership and all attendant rights of ownership of the weight of purchased precious metal or derivative, and holding the purchased precious metal or derivative in trust for the purchaser as held precious metal or derivative;
using the held precious metal as value/collateral for funding investments to derive a return on the investment;
or use the remaining funds in case of investment in derivatives to derive a return on the investment and
paying a portion of the derived return to the benefit of the purchaser as revenue on the precious metal instrument to provide said revenue bearing, precious metal instrument.

2. The investment method of claim 1, further comprising the step of: divesting the held precious metal or derivative and the collateral pursuant to the divestment request of the purchaser.

3. The investment method of claim 1, wherein said precious metal instrument is for ownership of a precious metal selected from the group consisting of: gold, silver, platinum and platinum group metals (including, rhodium, iridium, ruthenium, and osmium.

4. The investment method of claim 1, wherein in the receiving step, the precious metal purchased for the purchaser is certified to a standard of purity.

5. The selling step of claim 5, wherein the standard of purity is compliant with a certification standard and an in-house standard.

6. The investment method of claim 1, wherein the precious metal instrument evidencing the ownership includes the right to divest the held precious metal into the possession of the purchaser.

7. The investment method of claim 1, wherein the precious metal instrument vested in the purchaser evidences the ownership of a specific piece of precious metal or derivative to buy precious metal.

8. The investment method of claim 1, wherein the precious metal instrument vested in the purchaser evidences the ownership of a specific piece of precious metal, and the ownership rights includes the right to divest the specific piece of the held precious metal into possession of the purchaser.

9. The investment method of claim 1, including a transaction wherein the purchaser is a depositor and the purchase request is a deposit request to submit depositor owned precious metal or derivatives to be held by the trust enterprise as held precious metal.

10. The investment method of claim 9, wherein the precious metal instrument is vested in the depositor and evidences ownership specifically of the depositor owned precious metal held by the trust enterprise as held precious metal, and is limited on divestment to return of the previously submitted depositor owned precious metal.

11. The investment method of claim 1, wherein the special purpose vehicle enterprise comprises an Asset Management Group, a Trustee Group and a Depository Group.

12. The special purpose vehicle enterprise of claim 11, wherein the Trustee is a trustee appointed/approved by a national government.

13. The special purpose vehicle enterprise of claim 12, wherein the appointed/approved trustee is selected from the group consisting of: a national governmental agency, a national quasi-governmental agency (e.g., similar to the USPS), and a national government appointed trustee.

14. The Trustee of claim 12, wherein the national government is the national government of a country selected from the group consisting of: all country members of the United Nations, Switzerland and Luxembourg.

15. The Trustee of claim 14, wherein the Trustee is approved/provided by the Finance Office of the Nation of Luxembourg.
